(19) United States
(12) Patent Application Publication
(10) Pub. No.: US 2005/0185571 A1
(43) Pub. Date: Aug. 25, 2005

(54) Optical information recording medium

(75) Inventors: Kazuko Hanai, Kanagawa (JP); Hiroaki Takano, Kanagawa (JP); Takeshi Kakuta, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/063,549

(22) Filed: Feb. 24, 2005

(30) Foreign Application Priority Data
Feb. 24, 2004 (JP) 2004-048038

(51) Int. Cl. G11B 7/24

(52) U.S. Cl. 369/288; 369/94; 369/283

(57) ABSTRACT

The present invention provides an optical information recording medium which is not adversely affected by temperature and moisture during use and retains stable recording and reproducing properties over the long term. The optical information recording medium comprises a substrate, a recording layer formed on the substrate and a transparent sheet formed on the recording layer through an adhesive layer, wherein a surface of the transparent sheet is provided with a high-molecular compound layer having a saturated water absorption rate of 0.01% or less.

### CROSS-REFERENCE TO RELATED APPLICATION

This application claims priority under 35 USC 119 from Japanese Patent Application No. 2004-048038 the disclosure of which is incorporated herein.

### BACKGROUND OF THE INVENTION

1. Field of the Invention

The present invention relates to an optical information recording medium, and, particularly, to an optical information recording medium in which information can be written in a heat mode.

2. Description of the Related Art

There is a great need for further improvement in the recording density of information recording media (for example, DVDs) to record and reproduce large amounts of character information, image information and sound information. Research is being conducted regarding high-density recording of an optical information recording medium, with particular reference to the telerecording of digital high-vision TV broadcasting.

In these circumstances, following the development of violet laser, development of an optical disk system using a violet laser and a high NA pickup has been considered. Sony Corporation has introduced an “ISOM2000” DVR-Blue system which was a phase change recording medium using a violet laser. The layer structure of the phase change recording medium in DVR-Blue system is characterized by, for example, a 0.1-mm-thick transparent layer called a cover layer provided on the light incident side.

As a method of forming a 0.1-mm-thick transparent layer, applying a transparent sheet using an intermediate adhesive layer such as a ultraviolet ray-curable resin or a pressure-sensitive adhesive has been proposed (see, for example, Patent references: the publications of Japanese Patent Applications Laid-Open (JP-A) Nos. 2000-285520, 2002-8265 and 2000-67468).

The above-described optical information recording medium is used in applications such as TV telerecording and data storage in personal computers. Many of these media are used in an ambient temperature environment.

However, there are cases where the internal temperature of the drive actually used in these media is raised considerably by the heat generated by the device itself. Particularly in the case of long and continuous use, the internal temperature of the drive can reach 40° C. or more. Recording and reproduction in an optical disk are, of course, carried out in circumstances where the temperature thereof varies and it is therefore necessary to minimize the extent to which changes in temperature cause changes in the properties of an optical disk.

Generally, an optical information recording medium is provided with a recording layer containing a phase change material or an organic dye as a recording material, and a dielectric layer on a substrate. The recording layer and dielectric layer show minimal change in properties and are stable at temperatures ranging from room temperature to about 100° C. On the other hand, many ultraviolet ray-curable resins and pressure-sensitive adhesives which are used to apply a cover layer have a glass transition temperature (Tg) in the above temperature range. Depending on the environment in which they are used, transparent sheets may warp due to long term storage, and decomposed products generated by long term storage may migrate to the recording layer and the dielectric layer and sometimes react with these layers to produce precipitates or to cause coloring of the adhesive layer on the transparent sheet. The occurrence of these phenomena leads to changes in recording properties and stable recording and reproducing properties are therefore not obtained.

### SUMMARY OF THE INVENTION

In view of the above, an object of the present invention is to provide an optical information recording medium which is not adversely affected by temperature and humidity during use and retains stable recording and reproducing properties.

In order to attain the above object, the inventors of the present invention have conducted intensive research in order to develop a transparent sheet having favorable properties for storage, and as a result, invented an optical information recording medium having stable recording and reproducing properties over the long term with the temperature range of normal use.

An object of the present invention is to provide an optical information recording medium comprising a substrate, a recording layer formed on the substrate and a transparent sheet provided on the recording layer using an adhesive layer, wherein the transparent sheet is provided with a high-molecular compound layer having a saturated water absorption rate of 0.01 mass % or less on the surface thereof.

The effect of the invention will be explained below.

The inventors of the present invention have analyzed of the reasons for warpage of the transparent sheet, for the occurrence of precipitates in the recording and dielectric layers, and for coloring of the adhesive layer and the transparent sheet. We found that the transparent sheet absorbs moisture, and further that water penetrates into the adhesive layer and intermediate layers through the transparent sheet to cause hydrolysis, with the result that acidic materials produced thereby migrate to and react with the intermediate layers and the recording layer to cause precipitates and to cause coloring of the adhesive layer and transparent sheet. The inventors also found that the dielectric layer is eroded by water.

Therefore, in the invention, a high-molecular compound layer having a saturated water absorption rate of 0.01% or less is provided on the surface of the transparent sheet, whereby the absorption of water by the transparent sheet and water penetrating through the transparent sheet can be prevented, with the result that the optical information recording medium of the invention is not adversely affected by temperature and humidity during use and retains stable recording and reproducing properties over the long term.

### DETAILED DESCRIPTION OF THE INVENTION

The optical information recording medium of the present invention comprises a substrate, a recording layer disposed on the substrate and a transparent sheet formed on the recording layer through an adhesive layer, wherein the transparent sheet is provided with a specified high-molecular compound layer formed thereon.

Specifically, the optical information recording medium has, for example, a structure in which a reflecting layer, a recording layer, an intermediate layer and an adhesive layer are formed in this order on a substrate and a transparent sheet and a high-molecular compound layer in this order on the adhesive layer.

The optical information recording medium of the invention will be hereinafter explained using the above structure as an example.

<Substrate>

As the substrate, a proper material may be arbitrarily selected from various materials used as the substrate materials of conventional optical information recording media.

Examples of the substrate material may include glass; polycarbonates; acrylate resins such as a polymethylmethacrylate; vinyl chloride type resins such as a polyvinyl chloride and vinyl chloride copolymer; epoxy resins; amorphous polyolefins; polyesters; and metals such as aluminum. These materials may be used together as desired.

Among the above materials, polycarbonates and amorphous polyolefins are preferable and polycarbonates are particularly preferable from the viewpoint of moisture resistance, dimensional stability and low cost. Also, the thickness of the substrate is preferably 0.5 to 1.4 mm.

A tracking guide groove or irregularities (called a pre-groove or groove) reflecting information such as address signals are formed on the substrate. It is preferable to use a substrate provided with a pre-groove having a narrower track pitch than that of CD-Rs or DVD-Rs to attain a higher recording density.

Specifically, the track pitch of the pre-groove is preferably 300 to 600 nm. Also, the depth (groove depth) of the pre-groove is preferably 20 to 150 nm.

It is preferable to form an undercoat layer on the surface of the substrate, on which surface the reflecting layer, which will be explained later, is to be formed, for the purpose of improving flatness and adhesion.

Examples of materials used for the undercoat layer may include high-molecular materials such as a polymethylmethacrylate, acrylic acid/methacrylic acid copolymer, styrene/maleic anhydride copolymer, polyvinyl alcohol, N-methylolacrylamide, styrene/vinyltoluene copolymer, chlorosulfonated polyethylene, nitrocellulose, polyvinyl chloride, chlorinated polyolefin, polyester, polyimide, vinyl acetate/vinyl chloride copolymer, ethylene/vinyl acetate copolymer, polyethylene, polypropylene and polycarbonate; and surface modifiers such as silane coupling agents.

The undercoat layer may be formed by dissolving or dispersing the above material in an appropriate solvent to prepare a coating solution and by then applying the coating solution to the surface of the substrate by a coating method such as spin coating, dip coating or extrusion coating. The thickness of the undercoat layer is generally in a range from 0.005 to 20 μm and preferably in a range from 0.01 to 10 μm.

<Reflecting Layer>

A light reflecting material having a high reflectance for laser light is used in the reflecting layer. The reflectance is preferably 70% or more.

Examples of the light-reflecting material having a high reflectance may include metals or semimetals such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn and Bi and stainless steel. These light reflecting materials may be used singly or in combinations of two or more, or may be used as an alloy.

Preferable examples among these materials include Cr, Ni, Pt, Cu, Ag, Au, Al and stainless steel. More preferable examples include Au, Ag, Al and alloys of these metals and most preferable examples may include Au, Ag and alloys of these metals.

The reflecting layer may be formed by applying the aforementioned light-reflecting material to the substrate (the side on which the groove is formed) by vapor evaoration, sputtering or ion plating. The layer thickness of the reflecting layer is preferably 10 to 300 nm and is preferably made to fall in a range from 50 to 200 nm.

It is to be noted that the reflecting layer is unnecessarily provided when the reflectance of the following recording layer is sufficiently large.

<Recording Layer>

The recording layer is formed on the surface of the substrate on which the groove is formed (on the reflecting layer in the case where the reflecting layer is formed).

The recording layer may be either a layer containing an organic dye or a layer containing a phase change recording material (phase change recording layer). However, the recording layer is preferably the layer having an organic dye taking it into account, for example, to form sharp pits with ease.

The above organic dye is preferably at least one type selected from triazole type compounds, phthalocyanine compounds, porphyrin type compounds, aminobutadiene type compounds, merocyanine compounds and cyanine type compounds. The phthalocyanine compound is preferably at least one type selected from alkoxy substitution products, sulfonamide substitution products, sulfamoyl substitution products and sulfonic acid substitution products.

Also, dyes as described in each publication of JP-A Nos. 4-74690, 8-127174, 11-53758, 11-334204, 11-334205, 11-334206, 11-334207, 2000-43423, 2000-108513 and 2000-158818 may be combined with the above organic dye.

The recording layer may be formed as follows: recording materials such as the above dye (organic material) are dissolved together with a binder and the like, in an appropriate solvent to prepare a recording layer coating solution and then this recording layer coating solution is applied to the substrate or to the reflecting layer formed on the substrate to form a coating layer, followed by drying. The concentration of the recording material in the recording layer coating solution is preferably in a range from 0.01 to 15 mass %, more preferably in a range from 0.1 to 10 mass %, still more preferably in a range from 0.5 to 5 mass % and most preferably in a range from 0.5 to 3 mass %.

Also, as a method of dissolving the recording material and the like, ultrasonic treatment, a method using a homogenizer or heating may be applied.

Examples of the solvent used to prepare the recording layer coating solution may include esters such as butyl acetate, methyl acetate, ethyl acetate and cellosolve acetate; ketones such as methyl ethyl ketone, cyclohexanone and methyl isobutyl ketone; chlorinated hydrocarbons such as dichloromethane, 1,2-dichloroethane and chloroform; amides such as dimethylformamide; hydrocarbons such as methylcyclohexane; ethers such as tetrahydrofuran, ethyl ether and dioxane; alcohols such as ethanol, n-propanol, isopropanol and n-butanol diacetone alcohol; fluorine type solvents such as 2,2,3,3-tetrafluoropropanol; and glycol ethers such as ethylene glycol monomethyl ether, ethylene glycol monoethyl ether and propylene glycol monomethyl ether.

The above solvents may be used either singly or in combinations of two or more in consideration of the solubility of the recording material to be used. In the coating solution, various additives such as an antioxidant, UV absorber, plasticizer and lubricant may be added corresponding to the object.

When the binder is used, examples of the binder may include natural organic high-molecular materials such as a gelatin, cellulose derivatives, dextran, rosin and rubber; and synthetic organic polymers such as hydrocarbon type resins, e.g., a polyethylene, polypropylene, polystyrene and polyisobutylene; vinyl type resins, e.g., a polyvinyl chloride, polyvinylidene chloride and polyvinyl chloride/polyvinyl acetate copolymer; acryl resins, e.g., a methyl polyacrylate and methyl polymethacrylate; polyvinyl alcohol; polyethylene chloride; epoxy resin; butyral resin; rubber derivative; and initial condensates of heat-curable resins such as phenol/formaldehyde resin. When a binder is combined as the material of the recording layer, the amount of the binder is usually in a range from 0.01 equivalents to 50 equivalents (mass ratio) and preferably in a range from 0.1 to 5 equivalents (mass ratio) to the recording material. The concentration of the recording material in the coating solution prepared in the above manner is usually in a range from 0.01 to 10 mass % and preferably in a range from 0.1 to 5 mass %.

Examples of the coating method may include a spraying method, spin coating method, dip coating method, roll coating method, blade coating method, doctor rolling method and screen printing method. The recording layer may be a single layer or a multilayer. The thickness of the recording layer is usually in a range from 20 to 500 nm, preferably in a range from 30 to 300 nm and more preferably 50 to 100 nm.

Also, the coating temperature is 23 to 50° C. without any particular problem, is preferably 24 to 40° C. and more preferably 25 to 37° C.

The recording layer may be compounded of various fading preventives to improve the light fastness of the recording layer.

As the fading preventive, a singlet oxygen quencher is generally used. As the singlet oxygen quencher, those described in publications such as known patent specifications may be utilized.

Specific examples of the singlet oxygen quencher may include those described in, for example, each publication of JP-A Nos. 58-175693, 59-81194, 60-18387, 60-19586, 60-19587, 60-35054, 60-36190, 60-36191, 60-44554, 60-44555, 60-44389, 60-44390, 60-54892, 60-47069, 63-209995 and 4-25492, each publication of Japanese Patent Application Publication Nos. 1-38680 and 6-26028, the specification of DE Patent No. 350399 and Japan Chemical Society, the October issue (1992), page 1141.

The amount of the fading preventive such as the above singlet oxygen quencher is usually in a range from 0.1 to 50 mass %, preferably in a range from 0.5 to 45 mass %, more preferably 3 to 40 mass % and particularly preferably in a range from 5 to 25 mass %.

In the meantime, a phase change recording layer may be used as the recording layer. The phase change recording layer is a layer comprising a material which can be transformed repeatedly between a crystal phase and an amorphous phase by irradiation with laser light.

As the material used for the phase change recording layer, those transformed repeatedly between a crystal phase and an amorphous phase by the following method are given as examples. Specifically, when information is recorded, a concentrated laser light pulse is applied for a short time to melt the phase change recording layer partly. The melted part is quenched and solidified by thermal diffusion to form a record mark put in an amorphous state. Also, when the record is erased, the record mark portion is irradiated with laser light to heat the record mark portion to a temperature lower than the melting point of the recording layer and higher than the crystallization temperature of the recording layer and then the mark portion is cooled slowly to thereby crystallize the record mark put in an amorphous state, thereby returning the record mark to the original unrecorded state.

Specific examples of a material constituting the phase change recording layer include a Sb—Te alloy, Ge—Sb—Te alloy, Pd—Ge—Sb—Te alloy, Nb—Ge—Sb—Te alloy, Pd—Nb—Ge—Sb—Te alloy, Pt—Ge—Sb—Te alloy, Co—Ge—Sb—Te alloy, In—Sb—Te alloy, Ag—In—Sb—Te alloy, Ag—V—In—Sb—Te alloy and Ag—Ge—In—Sb—Te alloy. Among these alloys, a Ge—Sb—Te alloy and Ag—In—Sb—Te alloy are preferable because they can be rewritten plural times.

The layer thickness of the phase change recording layer is preferably 10 to 50 nm and more preferably 15 to 30 nm.

The above phase change recording layer may be formed by a vapor phase thin film deposition method such as a sputtering method and vacuum evaporation method.

<Intermediate Layer>

The intermediate layer is an optional layer formed between the above recording layer and the adhesive layer which will be explained later. When the adhesive layer is formed on the recording layer, there is the case where the adhesive or tackifier contained in the adhesive layer dissolves organic materials contained in the recording layer. In this case, the provision of the intermediate layer prevents the occurrence of the phenomenon that the adhesive or the like is brought into direct contact with the recording layer. It is therefore possible to prevent the recording layer from being dissolved by the adhesive or tackifier. Incidentally, the intermediate layer is called a dielectric layer or barrier layer.

The thickness of the intermediate layer is preferably 1 to 300 nm and more preferably 3 to 110 nm.

The material constituting the intermediate layer is preferably a dielectric material though any material may be used without any particular limitation insofar as it transmits laser light. More specific examples of the material constituting the intermediate layer include inorganic oxides, nitrides and sulfides such as ZnS, TiO₂, SiO₂, ZnS—SiO₂, GeO₂, Si₃N₄, Ge₃N₄ and MgF₂. Among these materials, ZnS—SiO₂ or SiO₂ is preferable.

<Adhesive Layer and Transparent Sheet>

The transparent sheet is formed to protect the inside of the optical information recording medium from chemical and physical variations.

The transparent sheet is formed on the recording layer or intermediate layer through an adhesive or tackifier.

An adhesive or a tackifier is used for the adhesive layer and it is preferable to use a tackifier in consideration of productivity and durability.

As the adhesive, an ultraviolet ray-curable resin is preferably used.

Examples of the tackifier include an acryl type, rubber type and silicone type. It is preferable to use an acryl type in consideration of durability and adhesion to the transparent sheet.

The acryl type tackifier contains, as major ingredients, a main monomer imparting tack, a copolymerizable monomer (comonomer) imparting internal cohesion and a functional monomer which forms a crosslinking point and contributes to adhesiveness, and is appropriately compounded of a crosslinking agent to improve cohesive force.

Examples of the main monomer include ethylacrylate, butylacrylate, 2-ethylhexylacrylate, isooctylacrylate and isononylacrylate.

Examples of the comonomer include vinyl acetate, acrylonitrile, acrylamide, styrene, methylmethacrylate and methylacrylate.

Examples of the functional monomer include unsaturated monobasic acids such as a methacrylic acid and acrylic acid, unsaturated dibasic acids such as itaconic acid, hydroxyethylmethacrylate, hydroxypropylmethacrylate, dimethylaminoethylmethacrylate, acrylamide, methylol acrylamide, glycidyl methacrylate, and maleic acid anhydride.

It is to be noted that there is the case where the acryl type tackifier does not contain the comonomer and the functional monomer but is constituted of plural types of main monomers.

It is possible to use an epoxy type or isocyanate type optionally as the crosslinking agent. These epoxy type or isocyanate type crosslinking agents may be added preferably in an amount of 0.1 to 10 mass parts based on 100 mass parts of the acryl type copolymer.

The acryl type copolymer obtained from these monomers preferably contains 30 to 90 mass % or more of the main monomer, 30 to 90 mass % of the comonomer and 0.1 to 10 mass % the functional monomer. To these monomers is added an isocyanate type crosslinking agent to obtain an acryl type tackifier. The average molecular weight of the above acryl type copolymer before it is crosslinked is preferably 10000 to 150000.

A tackifier capable of forming an adhesive layer having the aforementioned desired storage elastic modulus and peak temperature can be formed by making the acryl type copolymer have a composition and average molecular weight each falling in the above range.

When the adhesive is used to form the adhesive layer, for example, a method may be adopted in which the adhesive is first applied to the surface of the recording layer to which surface the transparent sheet is to be applied and thereafter, the transparent sheet is laminated on the adhesive layer and then secured to the applied surface by spin coating.

When the tackifier is used to form the adhesive layer, on the other hand, a method may be adopted in which the transparent sheet provided with the above tackifier is applied to the surface to which the transparent sheet is to be applied.

The thickness of the adhesive layer is preferably 5 to 50 μm and more preferably 10 to 30 μm.

Any material may be used as the material of the transparent sheet without any particular limitation insofar as it is transparent material. However, a polycarbonate or cellulose triacetate is preferable and a material of which the coefficient of moisture absorption at 23° C. under 50% RH is 5% or less is more preferable.

Also, the thickness of the transparent sheet is preferably 50 to 95 μm and more preferably 70 to 90 μm. When the thickness of the transparent sheet is less than 50 μm, the adhesive layer is so thick that it is difficult to apply the adhesive layer uniformly and there is the case where the standard (±3 μm) of the dispersion of thickness can be unsatisfied. When the thickness exceeds 95 μm, on the other hand, there is the case where it is difficult to satisfy the standard (100 μm) of the thickness of the cover layer.

Here, the term “transparent” means that a material is so transparent as to transmit (transparency: 90% or more) recording laser light and reproducing laser light.

<High-Molecular Compound Layer>

In the invention, it is essential to form a high-molecular compound layer having a saturated water absorption of 0.01% or less. Also, the saturated water absorption of the high-molecular compound layer is more preferably 0.005% or less.

When the saturated water absorption of the high-molecular compound layer exceeds 0.01%, the intrusion of moisture into the transparent sheet cannot be prevented, with the result that the optical information recording medium is largely affected by a change in temperature in a working circumstance.

Here, since the high-molecular compound layer in the invention cannot be formed by molding, the JIS method to be applied to a plastic molded product cannot be applied for the measurement of the saturated water absorption. Therefore, in the invention, the saturated water absorption was measured by adopting the following method.

First, a test piece provided with high-molecular compound layers on both surfaces of a transparent sheet by dipping or by application is manufactured. Then, the mass of the high-molecular compound is calculated from a change in mass before and after the high-molecular compound layer is formed in the process of producing this test piece. Next, the test piece is dipped in a water-absorption container filled with distilled water controlled at 23±0.5° C. for 24±1 hours and is then taken out. Then, the test piece is hung in a room at 24±1° C. under 75% RH for one hour and then water stuck to the surface of the test piece is removed. After that, this test piece is dipped in a Karl-Fischer reagent to measure water content quantitatively. The measured water mass is divided by the mass of the high-molecular compound to find the saturated water absorption in the invention.

Although this high-molecular compound layer is not particularly limited in the type of high-molecular compound constituting the layer insofar as the layer is transparent and the saturated water absorption of the layer is 0.01% or less, it is preferably constituted of a high-molecular compound containing a fluorine atom and/or a silicon atom in its molecule.

Examples of the high molecular compound containing a fluorine atom and/or a silicone atom include a perfluoropolyethers, polysiloxanes and silicone/fluorine copolymer resins which have almost no moisture absorption ability and no moisture penetration ability.

Here, the term “transparent” also means that a material is so transparent as to transmit (transparency: 90% or more) recording laser light and reproducing laser light.

The thickness of the high-molecular compound layer in the invention is preferably in a range from 0.001 to 10 μm, more preferably in a range from 0.003 to 1 μm and still more preferably in a range from 0.01 to 0.1 μm.

When the thickness of the high-molecular compound layer is less than 0.001 μm, the high-molecular compound layer scarcely exhibits the ability to prevent the intrusion of moisture into the transparent sheet. On the other hand, even if the thickness of the high-molecular compound layer exceeds 10 μm, the ability to prevent the intrusion of moisture into the transparent sheet is not so improved as is expected.

In this case, the thickness of the high-molecular compound layer shows a thickness after the layer is dried.

The high-molecular compound layer in the invention is preferably formed by dissolving the aforementioned high-molecular compound in a specific solvent to prepare a coating solution, which is then applied to the surface of the transparent sheet. As specific coating method, the same coating method that is used to form the aforementioned recording layer is used.

Here, various solvents may be used as the solvent for the coating solution. It is however preferable to select a solvent having the characteristics that it dissolves the high-molecular compound constituting the high-molecular compound layer but does not dissolve the transparent sheet.

If a high-molecular compound layer such as that used in the invention is formed on the surface of the transparent sheet, it is possible to prevent the unacceptable phenomena caused by the influence of a change in temperature in a working circumstance during storage or in the drive, these phenomena including, for example, the warpage of the transparent sheet caused by moisture absorption, the generation of precipitates resulting from a reaction between products obtained by hydrolysis and the intermediate layer or the recording layer and the coloring of the adhesive layer and transparent sheet caused by products obtained by hydrolysis.

As a result, the optical information recording medium of the invention is not adversely affected by the temperature and moisture in a working circumstance and is able to have always stable recording and reproducing characteristics.

Next, a method of recording information in the optical information recording medium of the invention and a method of reproducing the stored information will be explained.

Information is recorded in the optical information recording medium by the following manner.

First, recording laser light having a wavelength of 500 nm or less is applied from the transparent sheet side with rotating the optical information recording medium at a constant linear velocity.

When the recording layer is a layer containing a dye, the recording layer absorbs the applied laser light and the temperature thereof is thereby locally raised, which, for example, causes a physical or chemical change (for example, generation of pits) and this changes the optical characteristics of the recording layer to thereby record the information.

On the other hand, when the recording layer is a layer containing a phase change recording material, the irradiation with laser light and the quenching give rise to the crystallographic phase change (change from a crystal state to an amorphous state) of the applied portion whereby information is recorded.

Examples of a laser light source having an oscillation wavelength of 500 nm or less may include a violet semiconductor laser having an oscillation wavelength range from 390 to 415 nm and a bluish violet SHG laser having a center oscillation wavelength of about 430 nm.

The numerical aperture (NA) of the object lens used in the pickup to raise recording density is preferably 0.7 or more and more preferably 0.85 or more.

On the other hand, the stored information can be reproduced by applying laser light having a wavelength equal to or lower than that of the laser used to record information from the transparent sheet side and by detecting the reflected light.

### EXAMPLES

The present invention will be explained in more detail by way of examples. However, these examples should not be construed as limiting the scope of the invention.

### Example 1

(Production of a Transparent Sheet with an Adhesive Layer and a High-molecular Compound)

1) Preparation of a Solution

An acryl type copolymer (solvent: ethyl acetate/toluene=1/1, the same as follows) and an isocyanate type crosslinking agent (solvent: ethyl acetate/toluene=1/1, the same as follows) were mixed such that the ratio of the acryl type copolymer to the isocyanate type crosslinking agent was 100:1 (mass ratio) to prepare an adhesive coating solution A.

Also, perfluoropolyether (trade name: FG-3010, manufactured by (K.K.) Fluoro Technology) was dissolved in a solvent (n-heptane) to prepare a high-molecular compound coating solution B.

Further, a polysiloxane (trade name: KR282, manufactured by Shin-Etsu Silicone Co., Ltd.) was dissolved in a solvent (cyclohexane) to prepare a high-molecular compound coating solution C.

2) Coating, Drying and Winding

The adhesive coating solution A was continuously applied to one surface of a polyethylene film for separating which was wound roll-wise in a dry thickness of 20 μm with carrying the film. Then, the film was dried in a drying zone (100° C.) and then again wound roll-wise.

On the other hand, the high-molecular compound coating solution B was applied to one surface of a polycarbonate film (trade name: Pure Ace, manufactured by Teijin Limited, thickness: 80 μm) which was likewise wound roll-wise with carrying the film. Then, the film was dried in a drying zone (100° C.) and then again wound roll-wise.

Then, the adhesive layer surface of the film for separating which film was provided with the adhesive layer was applied to the polycarbonate surface of the polycarbonate film likewise provided with the high-molecular compound layer to form a laminate, which was then co-wound roll-wise. These both films put in the co-wound state were kept at 23° C. under 50% RH for 72 hours.

3) Punching and Keeping in a Horizontal State

The above laminate was punched so as to have the same shape as the substrate of the optical information recording medium to be produced, to manufacture a transparent sheet (transparent sheet with an adhesive layer and a high-molecular compound layer) for the optical information recording medium.

(Production of an Optical Information Recording Medium)

The groove side surface of a 1.1-mm thick and 120-mm-diameter injection molded polycarbonate resin (trade name: Panlight AD5503, a polycarbonate manufactured by Teijin Chemicals Ltd.) substrate provided with a spiral groove (100 nm, width: 120 nm and track pitch: 320 nm) was deposited with Ag by sputtering, to form a reflecting layer having a layer thickness of 100 nm.

Then, a phthalocyanine type dye A (trade name: Orazol Blue GN, manufactured by Ciba Specialty Chemicals Inc.) was added to 2,2,3,3-tetrafluoropropanol and dissolved by carrying out ultrasonic treatment for 2 hours to prepare a dye coating solution. The dye coating solution was applied to the reflecting layer in the condition of 23° C. and 50% RH by a spin coating method with changing the rotation between 300 rpm and 4000 rpm, to form a recording layer (thickness: 80 nm).

After the resulting product was stored at 23° C. under 50% RH for one hour, the recording layer was deposited with ZnS—SiO₂ by sputtering to form an intermediate layer 5 nm in thickness.

After the intermediate layer was formed, the film for separating was peeled from the above manufactured transparent sheet provided with the adhesive layer and the high-molecular compound layer and the adhesive layer surface was brought into contact with the intermediate layer to apply the transparent sheet to the intermediate layer by using a press means using rollers. An optical information recording medium was produced in this manner.

### Example 2

A transparent sheet was produced and then an optical information recording medium was produced in the same manner as in Example 1 except that the high-molecular compound layer was produced using a high-molecular compound coating solution C containing a polysiloxane.

### Example 3

A transparent sheet was produced and then an optical information recording medium was produced in the same manner as in Example 1 except that the transparent sheet was altered from the polycarbonate film to a triacetyl cellulose film (manufactured by Fuji Photo Film Co., Ltd.).

### Example 4

A transparent sheet was produced and then an optical information recording medium was produced in the same manner as in Example 2 except that the transparent sheet was altered from the polycarbonate film to a triacetyl cellulose film (manufactured by Fuji Photo Film Co., Ltd.).

### Comparative Example 1

A transparent sheet was produced and then an optical information recording medium was produced in the same manner as in Example 1 except that the high-molecular compound layer was not formed.

### Comparative Example 2

A transparent sheet was produced and then an optical information recording medium was produced in the same manner as in Example 2 except that the high-molecular compound layer was not formed.

With regard to the optical information recording media produced in Examples 1 to 4 and Comparative Examples 1 and 2, the material of the transparent sheet, the type of high-molecular compound layer (type of material constituting the high-molecular compound layer), the thickness of the high-molecular compound layer and the saturated water absorption of the high-molecular compound layer are shown in Table 1 below.

Here, the saturated water absorption of the high-molecular compound layer was measured according to aforementioned method of measuring the saturated water absorption in the invention.

TABLE 1

| | | Type of high- | Thickness of the | Saturated |
|---|---|---|---|---|
| | Material of the | molecular | high-molecular | water |
| | transparent sheet | compound layer | compound layer | absorption (%) |
| Example 1 | Polycarbonate | Perfluoropolyether | 0.5 μm | 0.002 |
| Example 2 | Polycarbonate | Polysiloxane | 0.5 μm | 0.005 |
| Example 3 | Triacetyl | Perfluoropolyether | 0.5 μm | 0.002 |
| | cellulose | | | |
| Example 4 | Triacetyl | Polysiloxane | 0.5 μm | 0.005 |
| | cellulose | | | |
| Comparative | Polycarbonate | — | — | — |
| Example 1 | | | | |
| Comparative | Triacetyl | — | — | — |
| Example 2 | cellulose | | | |

(Evaluation of the Characteristics of the Optical Information Recording Medium)

The optical information recording media manufactured in Examples 1 to 4 and Comparative Examples 1 and 2 were each stored in the circumstance of 80° C. and 85% RH. After one month, the surface of the optical information recording medium (surface of the high-molecular compound layer) was observed by an optical microscope and the surface (surface of the intermediate layer) when the transparent sheet with the high-molecular compound layer was peeled off together with the adhesive layer was observed by a scanning type electron microscope. The results of evaluation are shown in Table 2.

Also, the plane deflection of the optical information recording medium after the medium was stored was measured using DLD 4000 (Optical Disk Test System, manufactured by Japan E.M (K.K) to evaluate the warpage of the medium. The case where it was found that the plane deflection differed from the initial value by ±200 μm or more was transcribed as “X” and was judged to have a practical problem. The results of evaluation are shown in Table 2.

TABLE 2

| | Observation by | Observation by | |
|---|---|---|---|
| | an optical | a scanning type | Evaluation of |
| | microscope | electron microscope | warpage |
| Example 1 | Unchanged | Unchanged | good |
| Example 2 | Unchanged | Unchanged | good |
| Example 3 | Unchanged | Unchanged | good |
| Example 4 | Unchanged | Unchanged | good |
| Comparative | Unchanged | Generation of | X |
| Example 1 | | dot-like defect | |
| | | is confirmed | |
| Comparative | Generation | Unchanged | X |
| Example 2 | of dot-like defect | | |
| | is confirmed | | |

From the above results, the generation of precipitates, coloring and warpage of the transparent sheet were not observed even if these media were stored for a long period of time in the case of the optical information recording media manufactured in Examples 1 to 4.

In the case of the optical information recording media of Comparative Examples 1 and 2, on the contrary, the warpage of the transparent sheet which was caused by long term storage and posed a practical problem was observed. Also, in Comparative Example 1, a dot-like defect caused by a sulfide of Ag originated from an Ag ion which was thought to be supplied from the reflecting layer was observed. In Comparative Example 2, a dot-like defect was observed which was thought be caused by a reaction between diphenyl phosphate which was a hydrolysis product of a plasticizer (triphenyl phosphate) contained in a commercially available triacetyl cellulose film and a Zn ion of ZnS—SiO₂ constituting the intermediate layer.

According to the invention as mentioned above, an optical information recording medium can be provided which is not adversely affected by temperature and moisture during use and retains stable recording and reproducing characteristics.

1. An optical information recording medium comprising a substrate, a recording layer formed on the substrate and a transparent sheet formed on the recording layer using an intermediate an adhesive layer, wherein;
a surface of the transparent sheet is provided with a high-molecular compound layer having a saturated water absorption rate of 0.01 mass % or less.

2. An optical information recording medium according to claim 1, wherein the high-molecular compound layer comprises a high-molecular compound containing a fluorine atom and/or a silicone atom.

3. An optical information recording medium according to claim 1, wherein the high-molecular compound layer has a thickness of 0.001 to 10 μm.

4. An optical information recording medium according to claim 1, wherein the high-molecular compound layer has a thickness of 0.003 to 1 μm.

5. An optical information recording medium according to claim 1, wherein the substrate comprises a polycarbonate and has a thickness of 0.5 to 1.4 mm.

6. An optical information recording medium according to claim 1, wherein the substrate is provided with a pre-groove for tracking, the pre-groove having a track pitch of 300 to 600 nm and a depth of 20 to 150 nm.

7. An optical information recording medium according to claim 1, wherein the recording layer comprises an organic dye including at least one of a triazole type compound, a phthalocyanine type compound, a porphyrin type compound, an aminobutadiene type compound, a merocyanine compound and a cyanine type compound.

8. An optical information recording medium according to claim 1, wherein a phase change recording layer, the phase of which can be repeatedly changed between a crystal phase and an amorphous phase, is used as the recording layer.

9. An optical information recording medium according to claim 1, wherein an acryl type adhesive is used for the adhesive layer.

10. An optical information recording medium according to claim 1, wherein the adhesive layer has a thickness of 10 to 30 μm.

11. An optical information recording medium according to claim 1, wherein the transparent sheet is made of a material having a moisture absorption coefficient of 5% or less at 23° C. under 50% RH.

12. An optical information recording medium according to claim 1, wherein the high-molecular compound layer has a saturated water absorption rate of 0.005 mass % or less.
